(19) United States
(12) Patent Application Publication
(10) Pub. No.: US 2010/0147471 A1
(43) Pub. Date: Jun. 17, 2010

(54) Insect Screen Structures

(75) Inventor: Royston Douglas Bull, Hallam (AU)

Correspondence Address: MILLER LAW GROUP, PLLC, 25 STEVENS AVENUE, WEST LAWN, PA, 19609, US

(73) Assignee: Icon Plastics Pty, Ltd.

(21) Appl. No.: 12/332,431

(22) Filed: Dec. 11, 2008

(51) Int. Cl. E06B 9/52; E06B 9/24

(52) U.S. Cl. 160/381; 160/371

(57) ABSTRACT

A screen structure consists of a flexible screen mesh material retained in a plurality of edge engagement members forming a perimeter frame for the screen structure. Each of the engagement members is formed by a first part joined to a second part by a hinge structure. The first part has a wall formation extending longitudinally along and laterally therefrom. The wall formation is engagable in a complementary shaped groove to retain an edge region of the screen mesh material in the groove. Both of the wall formation and the groove are inclined in an outward direction when the wall formation is engaged in the groove.

### FIELD OF THE INVENTION

The present invention relates to improvements in products consisting of an outer, at least semi-rigid, perimeter frame with a flexible two dimensional material secured to and spanning an open space within the perimeter frame.

### BACKGROUND OF THE INVENTION

One major application is the retention of mesh or screen material to a perimeter frame to form an insect screen for windows or doors, however, while the invention will be described hereafter with regard to this application, it will be appreciated that many other applications are equally possible including, for example, the securing of edge regions of shade cloth, mesh or similar materials. Conventionally, fly wire mesh or similar screening material is secured to the perimeter frame, typically an extruded aluminium rectangular section assembled at corners, by providing a groove surrounding the opening to be spanned by the screening material. One edge of the screening material is secured by positioning same over the groove and forcing a beading member into the groove whereby the screening material is retained between the beading and the surface of the groove. Thereafter the screening material is pulled or stretched across the space and the opposite edge is secured by a similar method. Other edges or opposite pairs of edges are similarly secured. While the retention method works satisfactorily, installation processes are somewhat time consuming.

U.S. Pat. No. 3,729,045 and International patent specification no. PCT/SE93/00600 both disclose one piece edge mouldings including two main sections joined by a hinge structure whereby an edge region of insect screen material can be captured and held by a projecting wall element on one of the parts engaging in a groove formed in the other of the parts. The insect screen material, however still needs to be stretched across the opening formed by the edge mouldings in a screen structure formed therefrom.

### SUMMARY OF THE INVENTION

An objective of the present invention is to provide a simpler arrangement for securing flexible two dimensional material such as mesh or screening material to engagement means including perimeter frames formed therefrom and to automatically stretch such material during the fitting process. Conveniently the engagements may be extruded from a plastics material or a light weight metal including but not limited to aluminium or aluminium alloys.

According to a first aspect of this invention, an engagement member having an outer edge and an inner edge is provided, adapted to be assembled into a retaining structure for a product having a flexible two dimensional material secured to the retaining structure with the flexible two dimensional material extending from said inner edge, said engagement member having a substantially uniform cross-section with first and second parts connected by a longitudinally extending hinge line, one of said first or said second parts including a wall formation extending longitudinally and the other of said first or said second parts including a longitudinally extending first groove complementary in shape to said wall formation whereby in a first relative configuration of said first and second parts said wall formation is fully free of said first groove and in a second relative configuration of said first and second parts said wall formation is engagable in said first groove, said first groove and said wall formation being inclined towards said outer edge when in said second configuration. The engagement member might conveniently be made by extrusion of a suitable material. The flexible two dimensional material might be a substantially continuous web material such as a plastics film or it could be a mesh material such as shade cloth or any mesh material typically used for insect screening or the like. The engagement member may be a frame forming member adapted in some applications to form a perimeter frame such as in an insect screen construction. In other applications (eg shade mesh or the like), the engagement member might be positioned to hold edge regions of the flexible two dimensional mesh or screening material.

Conveniently, the first groove, when viewed in transverse cross-section, is curved with a radius of curvature being generally centred on the hinge line. The wall formation is preferably complementary in shape being also curved when viewed in transverse cross-section, with a similar radius of curvature. Conveniently, an inner end of the first groove is closer to the hinge line when measured in the plane of said frame forming member than is an entry zone to the first groove.

In one preferred arrangement, a catch means is provided between the first part and the second part to resist separation of the first part from the second part when said wall formation is operationally engaged with said first groove. Conveniently the wall formation has a first face facing towards the hinge line and a second face facing in an opposite direction, said catch means including a projecting lug extending longitudinally on either said first or said second face of the wall formation, said projecting lug being engagable with a longitudinally extending second groove in a wall of said first groove. Alternatively, the catch means may include a projecting lug extending longitudinally on either said first or said second first face of the wall formation, said projecting lug being engagable inwardly of a longitudinally and laterally inwardly extending projection in a wall of said first groove. Conveniently the longitudinally and laterally inwardly extending projection is located at or adjacent an entry zone to said first groove.

In a still further preferred embodiment the wall formation may be formed on said first part and said first groove is formed on said second part, said second part being movable about said hinge line when releasing therefrom or securing thereto, the flexible two dimensional material. The second part may include a longitudinally extending flange forming an inner face of said first groove, said flange having a laterally extending rib adapted to engage in an undercut region of said first part to releasably retain said rib therein when said wall formation is fully positioned in said first groove. The aforesaid rib may extend inwardly toward the hinge line and may be located at or adjacent a free end of the flange. Conveniently the first part has a base wall defining an outwardly facing base surface, said base wall including a first lip extending away from said hinge line located outwardly of said wall formation. Preferably the second part includes a portion positioned outwardly of said first groove complementary in shape to said first lip whereby said two dimensional material is located in the same plane as the base surface of said base wall when the wall formation is fully engaged in said first groove.

In yet another preferred arrangement, at least two longitudinally extending serration formations are provided in a wall of said first groove, said serrations being configured to not restrict entry of the wall formation into said first groove but to inhibit removal of said wall formation from said first groove. Preferably at least one longitudinally extending serration formation is formed on an outwardly directed face of said wall formation.

It is particularly preferred that the first and second parts be integrally formed with said hinge line, said frame forming member being extruded from a suitable plastics material. Alternatively the first and the second parts are extruded as separate parts and are formed by a hinge means forming said hinge line. The hinge means may be formed by a first hinge formation on the first part and a second hinge formation on the second part. The hinge means may also be a tape or web adhesively secured to the first and/or the second parts. In this embodiment at least one or possibly both the first and the second parts may be made from metal, typically a lightweight easily extrudable metal.

The present invention also anticipates providing a plurality of engagement members as aforesaid wherein at least two said engagement members meet at a corner, said corner include brace means having opposed ends each adapted to fit into internal hollow end zones of the engagement members. The present invention also anticipates providing an insect screen for a door window or similar including a perimeter frame made by an assembly of said engagement members, defining an internal space, said internal space being covered by a flexible mesh screen material, edge zones of said screen material being captured and retained in said first grooves of the engagement members.

By arranging the first groove and the complementary shaped wall formation inclined towards the outer edge of the engagement member or members, the flexible two dimensional material (insect screen material) is both stretched outwardly as well as being secured to the engagement members.

### BRIEF DESCRIPTION OF THE DRAWINGS

Several preferred embodiments will now be described with reference to the accompanying drawings, in which:

FIG. 1 is a perspective view of a possible frame forming member according to the preferred embodiment of the present invention;

FIG. 2 is a transverse cross-sectional view of the member shown in FIG. 1;

FIGS. 3, 4 and 5 are similar cross-section views showing steps of securing the flexible two dimensional material to the frame member shown in FIGS. 1 and 2; and

FIG. 6 is a detail view of area A circled in FIG. 5;

FIG. 7 is a partial exploded perspective view of a frame structure including an alternative preferred embodiments for the engagement members;

FIGS. 8, 9 and 10 are cross-sectional views of the alternative embodiment engagement members in various stages of use; and

FIGS. 11, 12 and 13 are cross-sectional views similar to FIGS. 8 to 10 showing a further alternative embodiment where the frame forming member is formed by two separable parts.

### DETAILED DESCRIPTION OF THE PREFERRED EMBODIMENT

Referring to the drawings, FIG. 1 illustrates an extruded elongate section 10, which may be formed into a frame an engagement member capable of being used as is or assembled to form. The section 10 is conveniently formed in one piece with a first part 11 and a second part 12 connected by a plastics material hinge line 13. The first part 11 includes a longitudinally extending wall formation 14 that is complementary in shape to an elongate groove 15 formed in the second part 12 wherein in a first position, the wall formation 14 can be fully removed from the groove 15 (FIG. 1) or in a second position, the wall formation 14 can be fully engaged in the groove 15 (FIGS. 5, 6). Movement of the first part 11 between the aforesaid positions occurs by pivoting the first part 11 relative to the second part 12 about the hinge line 13. While a one piece construction as illustrated in the drawings is preferred, it is equally possible to make the two parts 11, 12 individually or as separate extrusions which may then be connected by a hinge tape, mechanical hinge structure or similar to form the hinge line 13. In this case, the separate extrusions might be formed from either a plastics material or a metal including aluminium and aluminium alloys, steel including stainless steel and other metals suitable for the purpose.

As is shown in FIG. 1, the second part 12 is preferably hollow along its length to define an internal space 16 into which L-shaped corner stakes can be engaged and held by pressure and/or adhesives and/or fasteners. In this manner a rectangular frame may be produced. It will of course be appreciated that the extrusion 10 or the second part 12 might include a skirt region 17 to provide an infill area around the winder mechanism of a window assembly. Other variations of the basic extrusion design are possible depending on particular applications.

As can be seen in FIG. 2, the wall formation 14 is curved when viewed in transverse section and the curvature is circular with a radius based on the hinge line 13. The groove 15 is of course also preferably curved in transverse section with the radius of curvature centred on the hinge line 13. The groove 15 has on its outer surface face 18 adjacent the entry 19 to the groove 15, a longitudinally extending flange 20. The wall formation 14 has a longitudinally extending ridge or similar projection 21 that, in use snaps past the flange 20 such that its outer edge is retained behind the inner edge of the flange 20 (FIGS. 5, 6). It will of course be appreciated that the ridge 21 might be arranged to fit within a groove on the face 18 of the groove 15. Alternatively, a ridge, flange, projection or other formation could be positioned on the second part 12 and be configured to engage in a complementary catch formation on the first part 11, for example a groove or similar on the inner surface face 22 of the wall formation 14. As is also seen in FIG. 6, the inner face 23 of the groove 15, and possibly also the inner face 24 of the wall formation 14 may include serrations 28, 29 to promote holding of the flexible sheet material 25 (fly wire screen material or the like) between the surfaces 23, 24 (FIG. 6). Finally, the first part 11 includes a flange 26 inwardly of the wall formation 14 that engages against a ledge 27 when the wall formation 14 is pressed into the groove 15.

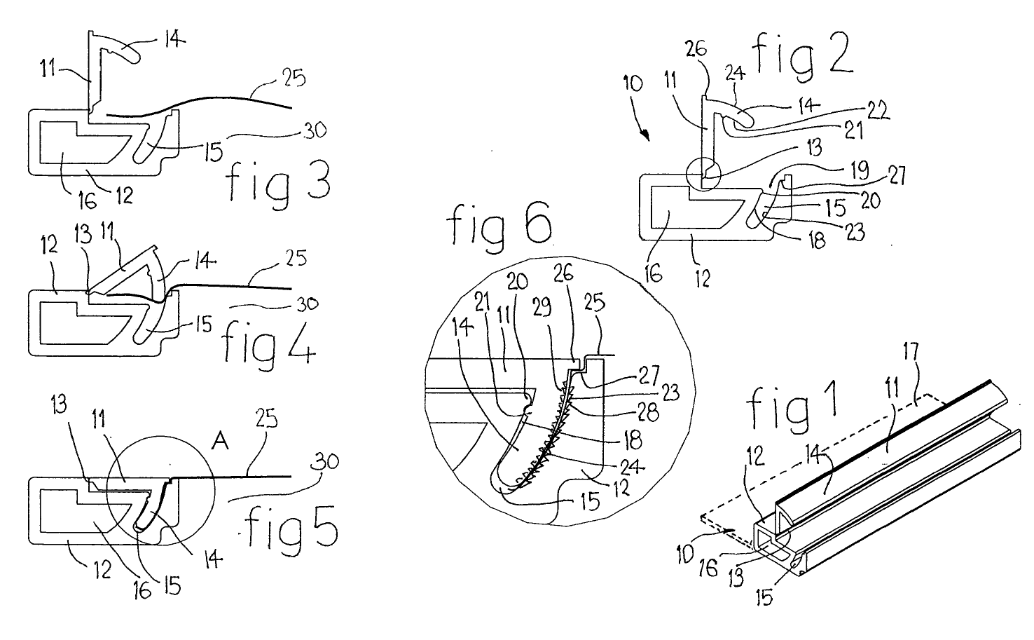

FIGS. 3 to 5 show the steps of installing a flexible sheet material 25 such as a wire or plastics mesh suitable for use as an insect screen, to a frame 30 formed from a plurality of frame forming members such as described above with reference to FIGS. 1, 2 and 6. As can be seen in FIG. 3, the mesh material 25 is cut to span across the open entry 19 of the groove 15 with the first part 11 in an open position. Thereafter the part 11 is pivoted about the hinge line 15 and the wall formation 14 engages the mesh material 25 pushing into the groove 15. In doing so the mesh material 25 is pulled downwardly and outwardly across the ledge 27 to tension the material 23 across the space 30 within the frame. Once the first part 11 reaches the position shown in FIG. 5, the ridge 21 snaps past the flange 20 to retain the part 11 in the illustrated closed position (FIGS. 5, 6). In this condition the mesh material 25 preferably extends to the bottom of the wall formation 14, and preferably around the bottom and up a short distance along the wall 18 of the groove 15. The serrations 28, 29, if provided, resist movement of the mesh material in a loosening direction.

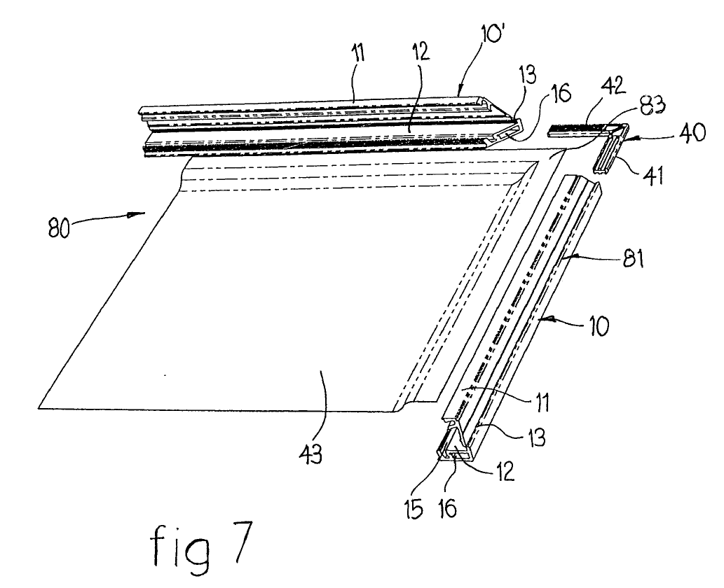

Reference will now be made to FIGS. 7 to 10 of the annexed drawings. FIG. 7 shows an exploded perspective view of one corner region of a frame structure 80 that might be an insert screen or similar. The drawing shows two engagement members 10 and 10′, the detail structure of which will be described later, meeting at a corner and held in relative position by a corner stake 40 with legs 41, 42 at right angles to each other engaging in the hollow internal space 16 of the engagement members 10, 10′. The corner stake 40 might be connected to the members 10, 10 by pressure, and/or gluing, and/or mechanical fasteners. In practice a perimeter frame is assembled utilizing desired lengths of engagement members 10, 10′ mitred at the corners and secured by corner stakes 40. Once the perimeter frame 81 is assembled, the outer dimension of same is used as a template to cut the mesh material 43 to the required dimensions, i.e. the mesh material 43 is laid on a flat surface with the perimeter frame placed there over. The mesh material may then be cut to the same dimension as the outer edge of the perimeter frame. Subsequently, the perimeter frame is positioned on the flat surface with the first parts 11 of the engagement members 10, 10′ open fully. The mesh material is then positioned over the perimeter frame 81 and secured along one side of the perimeter frame by pivoting the first part 11 down over the mesh to force the mesh into the first groove 15 in the second part 12. The same process is then completed along the other sides. For heavier mesh materials, the corners 83 of the mesh 43 might be cut off to prevent it bunching in the corners as the first parts 11 are engaged with the second parts 12 of the engagement members 10, 10′. Moreover, completing the foregoing process on a flat support surface will prevent the mesh material 43 sagging in the interior of the perimeter frame 81.

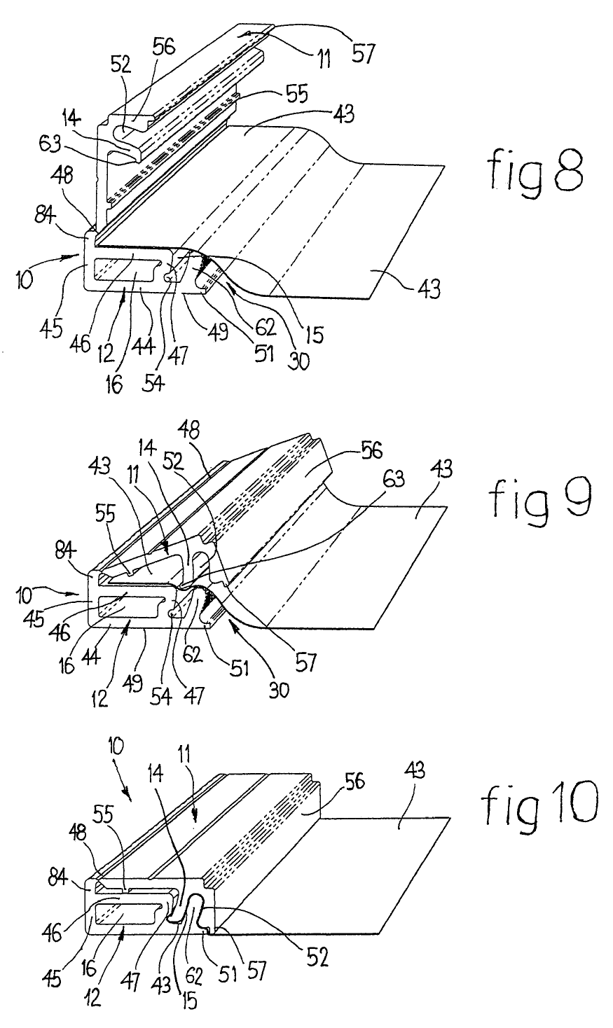

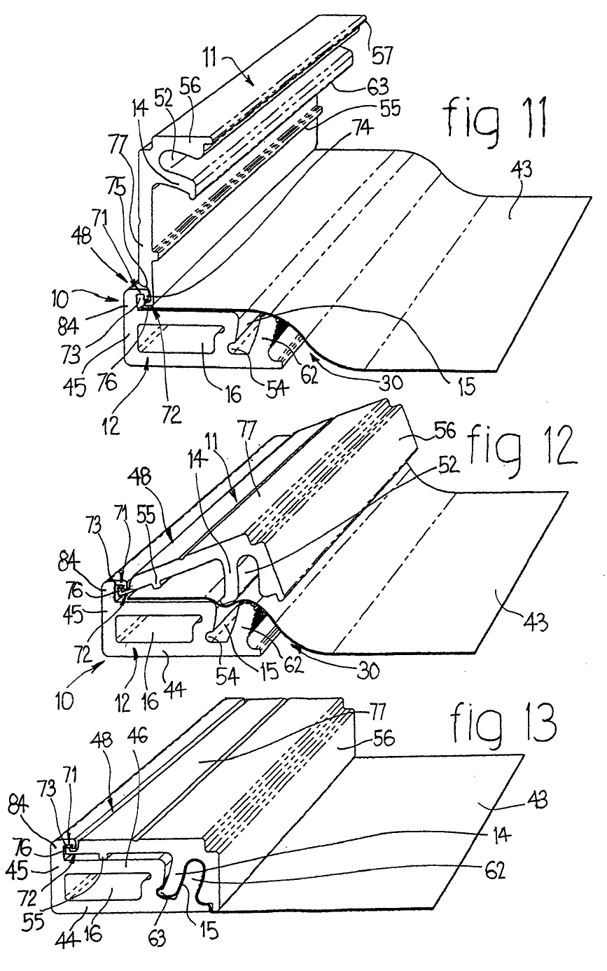

Reference is now made to FIGS. 8 to 10. In this preferred embodiment of the engagement member 10, the second part 12 has a base wall 44 and outer side wall 45 and an interior first wall 46 parallel to the base wall 44 and an interior second wall 47 generally parallel to the outer side wall 45 defining the hollow interior space 16. The outer side wall 45 has a flange section 84 extending beyond the first interior wall 46 and the first part 11 is hinged thereto along a hinge line 48. The base wall 44 has an outer generally flat base surface 49. A portion 50 of the base wall 44 extends beyond the interior second wall 47 and an upstanding wall formation 62 is formed thereon. The wall formation 62 defines an inner wall of a first groove 15 which in cross-section is curved having its radius of curvature centred on the hinge line 48. The wall formation 62 is also located inwardly of an outer lip formation 51 of the base wall 44. The groove 15 between the wall formation 62 and the interior second wall 47 is adapted to receive a flange 14 on the first part 11, the flange 14 having an inwardly directed laterally extending rib 63 adapted to be received in an undercut region 54 of the interior second wall 47 (see FIG. 10).

The first part 11 includes a rib 55 positioned intermediate the wall formation 14 and the hinge line 48 to prevent this region of the second part 12 from being unduly depressed to a degree that might damage the hinge line 48. A groove 52 is located between the wall formation 14 and an inner side wall 56, the groove 52 being complementary in shape to the wall formation 62 to accommodate same therein as shown in the drawings. The outer free end of the wall 56 is shaped as a lip 57 complementary to the outer lip formation 51 of the base wall 44 such that in the configuration of FIG. 10 the free lip 57 of the wall 56 is located in the plane of the base wall surface 49 as is the mesh material 43. As shown in FIG. 8, the mesh material 43 after being cut to size as previously explained, has its edge abutted up to the inside of the hinge line 48. Thereafter the first part 11 is closed about the hinge line 48 progressively drawing the mesh material 43 inwardly from the space 30 and from the hinge line 48 (FIG. 9) to eventually reach the retained position (FIG. 10).

FIGS. 11 to 13 show a further embodiment similar to that shown in FIGS. 8 to 10 except that the frame forming engagement member 10 has two separate parts, a first part 11 and a second part 12. Like features shown and described above with reference to FIGS. 8 to 10 have been given the same reference numbers. In this further preferred embodiment, the hinge line 48 is formed by two hinge forming formations, a first hinge formation 71 formed on an edge zone of the second part 12 and a second hinge formation 72 formed on an edge zone of the first part 11. The first hinge formation 71 comprises a downwardly facing open groove 73 disposed inwardly of the extension 84 of the outer side wall 45 and outwardly of an inner located lip 74. As shown in the drawings, the second hinge formation 72 comprises an upwardly facing open groove 75 between an outer edge lip 76 and the top wall 77 of the first part 11. The outer edge lip 76 engages in the open groove 73 as the second part 12 hinges relative to the second part 12 as shown from FIGS. 11 to 13 in the accompanying drawings.

It will of course be appreciated that many other variations to the structure of the frame forming member and products produced thereby are possible within the scope of the claims as annexed hereto.

1. An engagement member having an outer edge and an inner edge adapted for use as a retaining structure for a product having a flexible two dimensional material secured to the retaining structure extending from said inner edge of the engagement member, said engagement member having a substantially uniform cross-section with first and second parts connected by a longitudinally extending hinge line, one of said first or said second parts including a wall formation extending longitudinally and the other of said first or said second parts including a longitudinally extending first groove complementary in shape to said wall formation whereby in a first relative configuration of said first and second parts said wall formation is fully free of said first groove and in a second relative configuration of said first and second parts said wall formation is engagable in said first groove, said first groove and said wall formation being inclined towards said outer edge when in said second configuration.

2. An engagement member according to claim 1 wherein said first groove, when viewed in transverse cross-section, is curved with a radius of curvature generally centred on said hinge line.

3. An engagement member according to claim 2 wherein said wall formation, when viewed in transverse cross-section, is curved with a radius of curvature generally centred on said hinge line.

4. An engagement member according to claim 1 wherein a catch means is provided operative between the first part and the second part to resist separation of said first part from said second part when said wall formation is operationally engaged with said first groove.

5. An engagement member according to claim 4 wherein the wall formation has a first face facing towards the hinge line and a second face facing in an opposite direction, said catch means including a projecting lug extending longitudinally on either said first or said second face of the wall formation, said projecting lug being engagable with a longitudinally extending second groove in a wall of said first groove.

6. An engagement member according to claim 4 wherein the wall formation has a first face facing towards the hinge line, and a second face facing in an opposition direction, said catch means including a projecting lug extending longitudinally on either said first or said second first face of the wall formation, said projecting lug being engagable inwardly of a longitudinally and laterally inwardly extending projection in a wall of said first groove.

7. An engagement member according to claim 6 wherein the longitudinally and laterally inwardly extending projection is located at or adjacent an entry zone to said first groove.

8. An engagement member according to claim 1 wherein said wall formation is formed on said first part and said first groove is formed on said second part, said second part being movable about said hinge line when releasing therefrom or securing thereto, the flexible two dimensional material.

9. An engagement member according to claim 8 wherein said second part includes a longitudinally extending flange forming an inner face of said first groove, said flange having a laterally extending rib adapted to engage in an undercut region of said first part to releasably retain said rib therein when said wall formation is fully positioned in said first groove.

10. An engagement member according to claim 9 wherein said rib extends inwardly toward said hinge line.

11. An engagement member according to claim 9 wherein said rib is located at or adjacent a free end of said flange.

12. An engagement member according to claim 8 wherein said first part has a base wall defining an outwardly facing base surface, said base wall including a first lip extending away from said hinge line located outwardly of said wall formation.

13. An engagement member according to claim 12 wherein said second part includes a portion positioned outwardly of said first groove complementary in shape to said first lip whereby said two dimensional material is located in the same plane as the base surface of said base wall when the wall formation is fully engaged in said first groove.

14. An engagement member according to claim 4 wherein at least two longitudinally extending serration formations are provided in a wall of said first groove, said serrations being configured to not restrict entry of the wall formation into said first groove but to inhibit removal of said wall formation from said first groove.

15. An engagement member according to claim 4 wherein at least one longitudinally extending serration is formed on an outwardly directed face of said wall formation.

16. An engagement member according to claim 1 wherein said first and said second parts are integrally formed with said hinge line, said engagement member being extruded from a suitable plastics material.

17. An engagement member according to claim 1 wherein said first and said second parts are extruded as separate parts and are operationally joined by hinge means, at least in said second configuration, forming said hinge line.

18. An engagement member according to claim 17 wherein said hinge means includes a first hinge formation on said first part and a second hinge formation on said second part.

19. An engagement member according to claim 17 wherein the separate hinge means is a hinge tape or web adhesively secured to said first and said second parts.

20. A frame comprising:
a plurality of engagement members arranged such that adjacent two of said engagement members meet at respective corners, each said engagement member having an outer edge and an inner edge adapted for use as a retaining structure for a product having a flexible two dimensional material secured to the retaining structure extending from said inner edge of the engagement member, said engagement member having a substantially uniform cross-section with first and second parts connected by a longitudinally extending hinge line, one of said first or said second parts including a wall formation extending longitudinally and the other of said first or said second parts including a longitudinally extending first groove complementary in shape to said wall formation whereby in a first relative configuration of said first and second parts said wall formation is fully free of said first groove and in a second relative configuration of said first and second parts said wall formation is engagable in said first groove, said first groove and said wall formation being inclined towards said outer edge when in said second configuration.

21. The frame of claim 20 wherein each said corner includes a brace member having opposed ends adapted to fit into respective internal hollow end zones of the engagement members.

22. An insect screen panel comprising:
a frame having an internal space defined by a plurality of peripherally positioned engagement members, each said engagement member having an outer edge and an inner edge adapted for use as a retaining structure for a product having a flexible two dimensional material secured to the retaining structure extending from said inner edge of the engagement member, said engagement member having a substantially uniform cross-section with first and second parts connected by a longitudinally extending hinge line, one of said first or said second parts including a wall formation extending longitudinally and the other of said first or said second parts including a longitudinally extending first groove complementary in shape to said wall formation whereby in a first relative configuration of said first and second parts said wall formation is fully free of said first groove and in a second relative configuration of said first and second parts said wall formation is engagable in said first groove, said first groove and said wall formation being inclined towards said outer edge when in said second configuration; and
a flexible mesh screen material covering said internal space, said mesh screen material having edge zones captured and retained in said first grooves of the engagement members.
